(19) United States
(12) Patent Application Publication
(10) Pub. No.: US 2026/0079360 A1
(43) Pub. Date: Mar. 19, 2026

(54) PHASE SHIFTER FOR OPTICAL COMMUNICATIONS SYSTEMS

(71) Applicant: TAARA Connect, Inc., Sunnyvale, CA (US)

(72) Inventors: Simon Bilodeau, Los Altos, CA (US); Tymon Barwicz, Holmdel, NJ (US)

(21) Appl. No.: 19/290,559

(22) Filed: Aug. 5, 2025

Related U.S. Application Data
(60) Provisional application No. 63/694,932, filed on Sep. 16, 2024.

(51) Int. Cl. G02F 1/015; G02F 1/025; H04B 10/61

(52) U.S. Cl. CPC G02F 1/0154; G02F 1/025; H04B 10/61; G02F 2201/063; G02F 2201/12; G02F 2202/09; G02F 2203/50

(57) ABSTRACT

Aspects of the disclosure provide phase shifters as well as systems and methods in which those phase shifters may be utilized. For instance, a first phase shifter may consist of silicon material and may have a first electrode, a strip waveguide, and a second electrode. The strip waveguide may be arranged between the first electrode and the second electrode such that there is a first gap between the first electrode and the strip waveguide and a second gap between the second electrode and the strip waveguide such that there is no physical contact between the electrodes and the strip waveguide. The first electrode may be hole-doped, the strip waveguide may have no doping, and the second electrode may be electron-doped.

### CROSS REFERENCE TO RELATED APPLICATIONS

The present application claims the benefit of the filing date of U.S. Provisional Application No. 63/694,932, filed Sep. 16, 2024, the entire disclosure of which is incorporated by reference herein.

### BACKGROUND

Wireless optical communication enables high-throughput and long-range communication, in part due to high gain offered by the narrow angular width of the transmitted beam. However, the narrow beam also requires that it must be accurately and actively pointed in order to remain aligned to an aperture of a communications terminal at the remote end. This pointing may be accomplished by small mirrors (e.g., MEMS or voice-coil based fast-steering mirror mechanisms) that are actuated to steer the beam. In other implementations, electro-optic steering of beams with no moving parts is used to steer the beam, which provides cost, lifetime and performance advantages. Optical Phased Arrays (OPAs) are a critical technology component, with added benefits of adaptive-optics, point-to-multipoint support, and mesh network topologies. Each active element in the OPA requires electro-optic phase shifting capability.

### BRIEF SUMMARY

Aspects of the disclosure provide a phase shifter consisting of a silicon material. The phase shifter includes a first electrode, a strip waveguide, and a second electrode. The strip waveguide is arranged between the first electrode and the second electrode such that there is a first gap between the first electrode and the strip waveguide such that there is no physical contact between the first electrode and the strip waveguide and there is a second gap between the second electrode and the strip waveguide such that there is no physical contact between the second electrode and the strip waveguide. In addition, the first electrode is hole-doped, the strip waveguide has no doping, and the second electrode is electron-doped.

In one example, the silicon material is one of Si, SiO2, or SiN. In another example, the first electrode includes a first portion having a first height and a second portion having a second height, and the first height is greater than the second height. In this example, the second portion is directly adjacent to the first gap. In addition, or alternatively, the first portion is an unetched portion, the second portion is a partially etched portion, and the first gap is fully etched. In addition or alternatively, the second portion is adjacent to a third portion of the first electrode, and a height of the third portion is greater than a height of the second portion. In this example, the third portion is directly adjacent to the first gap. In addition or alternatively, the first portion is an unetched portion, the second portion is a partially etched portion, the third portion is an unetched portion, and the first gap is fully etched. In addition or alternatively, the first portion is arranged at an outer edge of the phase shifter. In another example, the phase shifter includes a substrate wherein the first electrode, second electrode, and strip waveguide are arranged directly on the substrate.

Another aspect of the disclosure provides a system. The system includes a first communications terminal including an optical phased array (OPA) architecture including a plurality of phase shifters configured to receive an optical communications beam from a second communications terminal, and the plurality of phase shifters includes a first phase shifter consisting of silicon material. The first phase shifter has a first electrode, a strip waveguide, and a second electrode. The strip waveguide is arranged between the first electrode and the second electrode such that there is a first gap between the first electrode and the strip waveguide such that there is no physical contact between the first electrode and the strip waveguide, and there is a second gap between the second electrode and the strip waveguide such that there is no physical contact between the second electrode and the strip waveguide. In addition, the first electrode is hole-doped, the strip waveguide has no doping, and the second electrode is electron-doped.

In one example, the first electrode includes a first portion having a first height and a second portion having a second height, wherein the second height is greater than the first height. In this example, the second portion is directly adjacent to the first gap. In addition, or alternatively, the first portion is an unetched portion, the second portion is a partially etched portion, and the first gap is fully etched. In addition or alternatively, the second portion is adjacent to a third portion of the first electrode, and the second height of the second portion is greater than a height of the third portion. In this example, the first portion is an unetched portion, the second portion is a partially etched portion, the third portion is an unetched portion, and the first gap is fully etched. In another example, the first portion is arranged at an outer edge of the first phase shifter. In another example, the system also includes a substrate wherein the first electrode, second electrode, and strip waveguide are arranged directly on the substrate. In another example, the system also includes the second communications terminal, and the second communications terminal having a second OPA architecture including a plurality of phase shifters configured to receive an optical communications beam from the first communications terminal. In addition, the plurality of phase shifters includes a second phase shifter having a same configuration as the first phase shifter.

A further aspect of the disclosure provides a method. The method includes receiving, at a first communications terminal, light through an aperture. The method also includes passing the received light to a phase shifter of an OPA architecture. The phase shifter consists of silicon material and including a first electrode, a strip waveguide, and a second electrode. The strip waveguide is arranged between the first electrode and the second electrode such that there is a first gap between the first electrode and the strip waveguide such that there is no physical contact between the first electrode and the strip waveguide, and there is a second gap between the second electrode and the strip waveguide such that there is no physical contact between the second electrode and the strip waveguide. The first electrode is hole-doped, the strip waveguide has no doping, and the second electrode is electron-doped. The method also includes providing, using the phase shifter, the received light to receiver components including a sensor, receiving, using the phase shifter, light to be transmitted, and transmitting the light to be transmitted through the aperture and to a second communications terminal.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a block diagram 100 of a first communications terminal and a second communications terminal in accordance with aspects of the disclosure.

FIG. 2 is a pictorial diagram 200 of an example system architecture for the first communication device of FIG. 1 in accordance with aspects of the disclosure.

FIG. 3 represents features of an OPA architecture represented as an example OPA chip in accordance with aspects of the disclosure.

FIG. 4 is a pictorial diagram of a network in accordance with aspects of the disclosure.

FIG. 5 is an example side, cross-sectional view of a phase shifter in accordance with aspects of the disclosure.

FIG. 6 is an example side, cross-sectional view of a phase shifter in accordance with aspects of the disclosure.

FIG. 7 is an example side, cross-sectional view of a phase shifter in accordance with aspects of the disclosure.

FIG. 8 is an example partial top-down perspective view of a phase shifter in accordance with aspects of the disclosure.

FIG. 9 is an example partial top-down perspective view of a phase shifter in accordance with aspects of the disclosure.

FIG. 10 is an example partial top-down perspective view of a phase shifter in accordance with aspects of the disclosure.

FIGS. 11A, 11B, and 11C are example voltage profiles of different phase shifters in accordance with aspects of the disclosure.

FIGS. 12A, 12B, and 12C are example mode profiles of different phase shifters in accordance with aspects of the disclosure.

FIGS. 13A, 13B, and 13C are example electric profiles of different phase shifters in accordance with aspects of the disclosure.

FIG. 14 is a flow diagram in accordance with aspects of the disclosure.

FIG. 15 is an example configuration of modulator including a phase shifter in accordance with aspects of the disclosure.

FIG. 16 is an example configuration of modulator including a phase shifter in accordance with aspects of the disclosure.

FIG. 17 is an example configuration of modulator including a phase shifter in accordance with aspects of the disclosure.

FIG. 18 is an example configuration of modulator including a phase shifter in accordance with aspects of the disclosure.

### DETAILED DESCRIPTION

### Overview

The technology described herein relates to phase shifters which may be used in OPA architectures for optical communications systems. The technology relates to phase shifters which may be used in OPA architectures for optical communications systems. Phase shifters are used to electrically control the propagation of light in integrated photonic circuits, which enables a host of applications in telecommunications, signal processing, computing, and sensing. The ideal phase shifter functions according to the Pockels effect, where the refractive index of the material changes under an applied electric field. This is desirable because of negligible power consumption and low optical loss.

Silicon is a desirable material to fabricate photonic integrated circuits due to its mass fabricability. However, silicon itself does not have a native Pockels effect due to centrosymmetric crystalline structure. As a result, phase shifters fabricated from silicon either have large power consumption (thermo-optic phase shifters) or extra optical loss (free carrier-based phase shifters). Under a large DC applied electric field sufficient to cause sub-dielectric breakdown, the crystalline structure can be distorted to induce a nonzero Pockels coefficient. In the past, silicon phase shifters leveraging this effect have been avoided due to the inability to distinguish between a true Pockels effect and residual free carrier modulation, as well as being limited in maximum achievable phase shift by the dielectric strength of silicon.

To address these concerns, a silicon phase shifter structure is provided that minimizes spurious carrier modulation and enables pure Pockels modulation in the silicon, and may allow up to 100 times more actuation range due to being limited by the breakdown of insulating silicon dioxide instead of semiconducting silicon.

The feature described herein provide for phase shifters which may be used in OPA architectures for optical communications systems. Such phase shifters may provide “ideal” phase modulation utilizing a strip waveguide with an oxide separation to neighboring doped silicon electrodes with partially etched portions. This may greatly reduce currents (and hence charge redistribution) within the waveguide under high electric fields, ensuring that Pockels modulation dominates over free carrier modulation. In addition, this may allow for an approximately 100 times greater electric field—and hence optical phase shift—to be applied across the waveguide, since the breakdown field of silicon dioxide is ˜10⁷ V/cm, whereas reverse-biased silicon's is up to ˜10⁵ V/cm.

### Example Systems

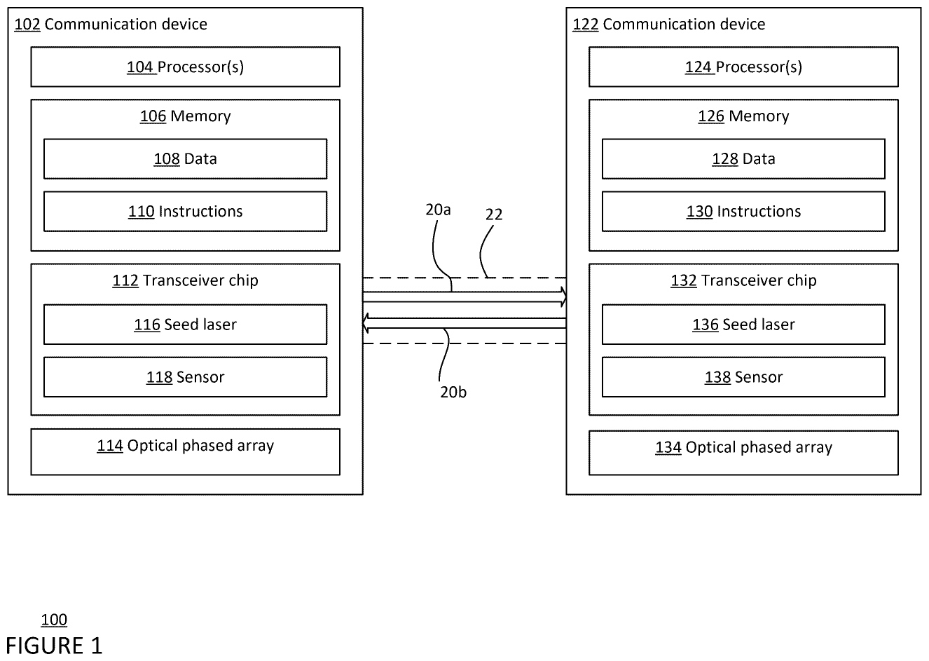

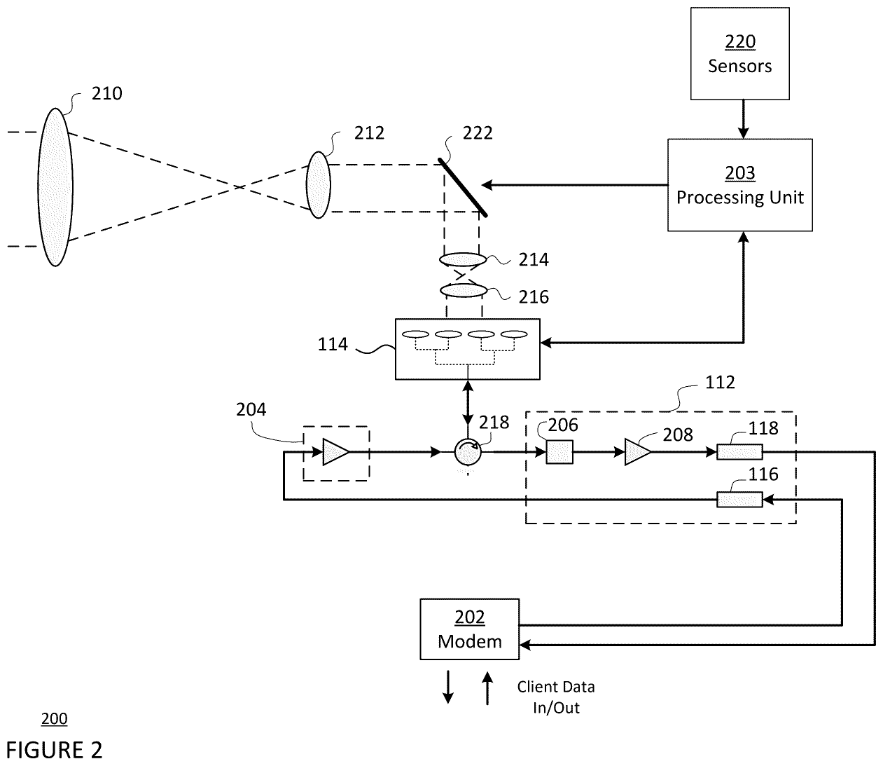

FIG. 1 is a block diagram 100 of a first communications terminal configured to form one or more links with a second communications terminal, for instance as part of a system such as a free-space optical communication (FSOC) system. FIG. 2 is a pictorial diagram 200 of an example communications terminal, such as the first communications terminal of FIG. 1. For example, a first communications terminal 102 includes one or more processors 104, a memory 106, a transceiver photonic integrated chip 112, and an optical phased array (OPA) architecture 114. In some implementations, the first communications terminal 102 may include more than one transceiver chip and/or more than one OPA architecture (e.g., more than one OPA chip).

The one or more processors 104 may be any conventional processors, such as commercially available CPUs. Alternatively, the one or more processors may be a dedicated device such as an application specific integrated circuit (ASIC) or another hardware-based processor, such as a field programmable gate array (FPGA). Although FIG. 1 functionally illustrates the one or more processors 104 and memory 106 as being within the same block, such as in a modem 202 for digital signal processing shown in FIG. 2, the one or more processors 104 and memory 106 may actually comprise multiple processors and memories that may or may not be stored within the same physical housing, such as in both the modem 202 and a separate processing unit 203. Accordingly, references to a processor or computer will be understood to include references to a collection of processors or computers or memories that may or may not operate in parallel.

Memory 106 may store information accessible by the one or more processors 104, including data 108, and instructions 110, that may be executed by the one or more processors 104. The memory may be of any type capable of storing information accessible by the processor, including a computer-readable medium such as a hard-drive, memory card, ROM, RAM, DVD or other optical disks, as well as other write-capable and read-only memories. The system and method may include different combinations of the foregoing, whereby different portions of the data 108 and instructions 110 are stored on different types of media. In the memory of each communications terminal, such as memory 106, calibration information, such as one or more offsets determined for tracking a signal, may be stored.

Data 108 may be retrieved, stored or modified by one or more processors 104 in accordance with the instructions 110. For instance, although the system and method are not limited by any particular data structure, the data 108 may be stored in computer registers, in a relational database as a table having a plurality of different fields and records, XML documents or flat files. The data 108 may also be formatted in any computer-readable format such as, but not limited to, binary values or Unicode. By further way of example only, image data may be stored as bitmaps including of grids of pixels that are stored in accordance with formats that are compressed or uncompressed, lossless (e.g., BMP) or lossy (e.g., JPEG), and bitmap or vector-based (e.g., SVG), as well as computer instructions for drawing graphics. The data 108 may comprise any information sufficient to identify the relevant information, such as numbers, descriptive text, proprietary codes, references to data stored in other areas of the same memory or different memories (including other network locations) or information that is used by a function to calculate the relevant data.

The instructions 110 may be any set of instructions to be executed directly (such as machine code) or indirectly (such as scripts) by the one or more processors 104. For example, the instructions 110 may be stored as computer code on the computer-readable medium. In that regard, the terms “instructions” and “programs” may be used interchangeably herein. The instructions 110 may be stored in object code format for direct processing by the one or more processors 104, or in any other computer language including scripts or collections of independent source code modules that are interpreted on demand or compiled in advance. Functions, methods and routines of the instructions 110 are explained in more detail below.

The one or more processors 104 may be in communication with the transceiver chip 112. As shown in FIG. 2, the one or more processors in the modem 202 may be in communication with the transceiver chip 112, being configured to receive and process incoming optical signals and to transmit optical signals. The transceiver chip 112 may include one or more transmitter components and one or more receiver components. The one or more processors 104 may therefore be configured to transmit, via the transmitter components, data in a signal, and also may be configured to receive, via the receiver components, communications and data in a signal. The received signal may be processed by the one or more processors 104 to extract the communications and data.

The transmitter components may include at minimum a light source, such as seed laser 116. Other transmitter components may include an amplifier, such as a high-power semiconductor optical amplifier 204. In some implementations, the amplifier is on a separate photonics chip. The seed laser 116 may be a distributed feedback laser (DFB), light-emitting diode (LED), a laser diode, a fiber laser, or a solid-state laser. The light output of the seed laser 116, or optical signal, may be controlled by a current, or electrical signal, applied directly to the seed laser, such as from a modulator that modulates a received electrical signal. Light transmitted from the seed laser 116 is received by the OPA architecture 114.

The receiver components may include at minimum a sensor 118, such as a photodiode. The sensor may convert a received signal (e.g., light or optical communications beam), into an electrical signal that can be processed by the one or more processors. Other receiver components may include an attenuator, such as a variable optical attenuator 206, an amplifier, such as a semiconductor optical amplifier 208, or a filter.

The one or more processors 104 may be in communication with the OPA architecture 114. The OPA architecture may include a micro-lens array, an emitter associated with each micro-lens in the array, a plurality of phase shifters, and waveguides that connect the components in the OPA. The OPA architecture may be positioned on a single chip, an OPA chip. The waveguides progressively merge between a plurality of emitters and an edge coupler that connect to other transmitter and/or receiver components. In this regard, the waveguides may direct light between photodetectors or fiber outside of the OPA architecture, the phase shifters the waveguide combiners, the emitters and any additional component within the OPA. In particular, the waveguide configuration may combine two waveguides at each stage, which means the number of waveguides is reduced by a factor of two at every successive stage closer to the edge coupler. The point of combination may be a node, and a combiner may be at each node. The combiner may be a 2×2 multimode interference (MMI) or directional coupler.

The OPA architecture 114 may receive light from the transmitter components and outputs the light as a coherent communications beam to be received by a remote communications terminal, such as second communications terminal 122. The OPA architecture 114 may also receive light from free space, such as a communications beam from second communications terminal 122, and provides such received light to the receiver components. The OPA architecture may provide the necessary photonic processing to combine an incoming optical communications beam into a single-mode waveguide that directs the beam towards the transceiver chip 112. In some implementations, the OPA architecture may also generate and provide an angle of arrival estimate to the one or more processors 104, such as those in processing unit 203.

The first communications terminal 102 may include additional components to support functions of the communications terminal. For example, the first communications terminal may include one or more lenses and/or mirrors that form a telescope. The telescope may receive collimated light and output collimated light. The telescope may include an objective portion, an eyepiece portion, and a relay portion. As shown in FIG. 2, the first communications terminal may include a telescope including a first lens 210 (e.g., an objective lens), an eyepiece lens 212, and an aperture 214 (or opening) through which light may enter and exit the communications terminal. For ease of representation and understanding, the aperture 214 is depicted as distinct from the first lens 210, though the first lens may be positioned within the aperture. The first communications terminal may include a circulator, such as a single mode circulator 218, that routes incoming light and outgoing light while keeping them on at least partially separate paths. The first communications terminal may include one or more sensors 220 for detecting measurements of environmental features and/or system components.

The first communications terminal 102 may include one or more steering mechanisms, such as one or more bias means for controlling one or more phase shifters, which may be part of the OPA architecture 114, and/or an actuated/steering mirror (not shown), such as a fast/fine pointing mirror. In some examples, the actuated mirror may be a MEMS 2-axis mirror, 2-axis voice coil mirror, or a piezoelectric 2-axis mirror. The one or more processors 104, such as those in the processing unit 203, may be configured to receive and process signals from the one or more sensors 220, the transceiver chip 112, and/or the OPA architecture 114 and to control the one or more steering mechanisms to adjust a pointing direction and/or wavefront shape. The first communications terminal also includes optical fibers, or waveguides, connecting optical components, creating a path between the seed laser 116 and OPA architecture 114 and a path between the OPA architecture 114 and the sensor 118.

Returning to FIG. 1, the second communications terminal 122 may output the Tx signals as an optical communications beam 20b (e.g., light) pointed towards the first communications terminal 102, which receives the optical communications beam 20b (e.g., light) as corresponding Rx signals. In this regard, the second communications terminal 122 include one or more processors, 124, a memory 126, a transceiver chip 132, and an OPA architecture 134. The one or more processors 124 may be similar to the one or more processors 104 described above.

Memory 126 may store information accessible by the one or more processors 124, including data 128 and instructions 130 that may be executed by processor 124. Memory 126, data 128, and instructions 130 may be configured similarly to memory 106, data 108, and instructions 110 described above. In addition, the transceiver chip 132 and the OPA architecture 134 of the second communications terminal 122 may be similar to the transceiver chip 112 and the OPA architecture 114. The transceiver chip 132 may include both transmitter components and receiver components. The transmitter components may include a light source, such as seed laser 136 configured similar to the seed laser 116. Other transmitter components may include an amplifier, such as a high-power semiconductor optical amplifier. The receiver components may include a sensor 138 configured similar to sensor 118. Other receiver components may include an attenuator, such as a variable optical attenuator, an amplifier, such as a semiconductor optical amplifier, or a filter. The OPA architecture 134 may include an OPA chip including a micro-lens array, a plurality of emitters, a plurality of phase shifters. Additional components for supporting functions of the second communications terminal 122 may be included similar to the additional components described above. The second communications terminal 122 may have a system architecture that is same or similar to the system architecture shown in FIG. 2.

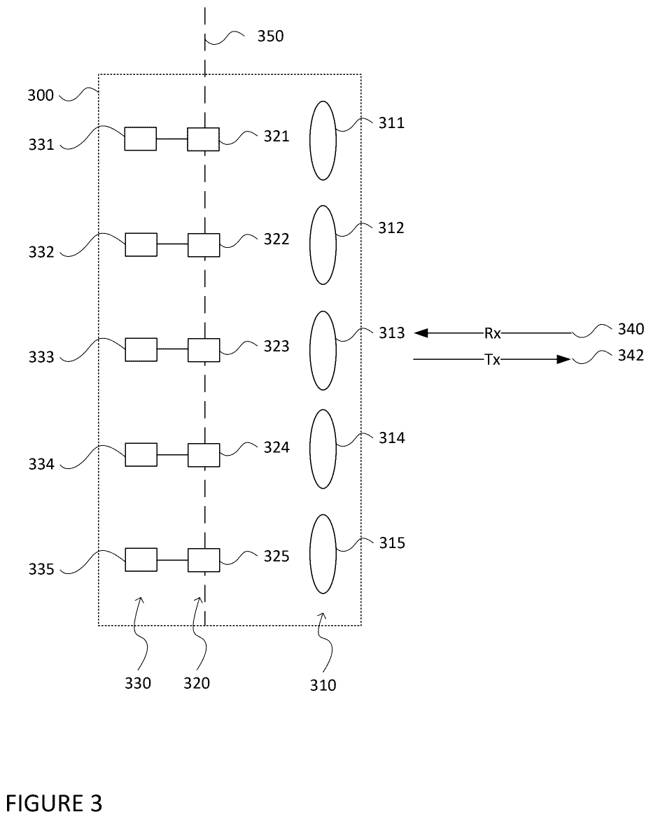

FIG. 3 represent features of OPA architecture 114 represented as an example OPA chip 300 including representations of a micro-lens array 310, a plurality of emitters 320, and a plurality of phase shifters 330. For clarity and ease of understanding, additional waveguides and other features are not depicted. Arrows 340, 342 represent the general direction of Tx signals (transmitted optical communications beam) and Rx signals (received optical communications beam) as such signals pass or travel through the OPA chip 300.

The micro-lens array 310 may include a plurality of convex lenses 311-315 that focus the Rx signals onto respective ones of the plurality emitters positioned at the focal points of the micro-lens array. In this regard, the dashed-line 350 represents the focal plane of the micro-lenses 311-315 of the micro-lens array 310. The micro-lens array 310 may be arranged in a grid pattern with a consistent pitch, or distance, between adjacent lenses. In other examples, the micro-lens array 310 may be in different arrangements having different numbers of rows and columns, different shapes, and/or different pitch (consistent or inconsistent) for different lenses.

Each micro-lens of the micro-lens array may be 10's to 100's of micrometers in diameter and height. In addition, each micro-lens of the micro-lens array may be manufactured by molding, printing, or etching a lens directly into a wafer of the OPA chip 300. Alternatively, the micro-lens array 310 may be molded as a separately fabricated micro-lens array. In this example, the micro-lens array 310 may be a rectangular or square plate of glass or silica a few mm (e.g. 10 mm or more or less) in length and width and 0.2 mm or more or less thick. Integrating the micro-lens array within the OPA chip 300 may allow for the reduction of the grating emitter size and an increase in the space between emitters. In this way, two-dimensional waveguide routing in the OPA architecture may better fit in a single layer optical phased array. In other instances, rather than a physical micro-lens array, the function of the micro-lens array may be replicated using an array of diffractive optical elements (DOE).

Each micro-lens of the micro-lens array may be associated with a respective emitter of the plurality of emitters 320. For example, each micro-lens may have an emitter from which Tx signals are received and to which the Rx signals are focused. As an example, micro-lens 311 is associated with emitter 321. Similarly, each micro-lens 312-315 also has a respective emitter 322-325. In this regard, for a given pitch (i.e., edge length of a micro-lens) the micro-lens focal length may be optimized for best transmit and receive coupling to the underlying emitters. This arrangement may thus increase the effective fill factor of the Rx signals at the respective emitter, while also expanding the Tx signals received at the micro-lenses from the respective emitter before the Tx signals leave the OPA chip 300.

The plurality of emitters 320 may be configured to convert emissions from waveguides to free space and vice versa. The emitters may also generate a specific phase and intensity profile to further increase the effective fill factor of the Rx signals and improve the wavefront of the Tx signals. The phase and intensity profile may be determined using inverse design or other techniques in a manner that accounts for how transmitted signals will change as they propagate to and through the micro-lens array. The phase profile may be different from the flat profile of traditional grating emitters, and the intensity profile may be different from the gaussian intensity profile of traditional grating emitters. However, in some implementations, the emitters may be Gaussian field profile grating emitters.

The phase shifters 330 may allow for sensing and measuring Rx signals and the altering of Tx signals to improve signal strength optimally combining an input wavefront into a single waveguide or fiber. Each emitter may be associated with a phase shifter. As shown in FIG. 3, each emitter may be connected to a respective phase shifter. As an example, the emitter 320 is associated with a phase shifter 330. The Rx signals received at the phase shifters 331-335 may be provided to receiver components including the sensor 118, and the Tx signals from the phase shifters 331-335 may be provided to the respective emitters of the plurality of emitters 320. The architecture for the plurality of phase shifters 330 may include at least one layer of phase shifters having at least one phase shifter connected to an emitter of the plurality of emitters 320. In some examples, the phase shifter architecture may include a plurality of layers of phase shifters, where phase shifters in a first layer may be connected in series with one or more phase shifters in a second layer.

A communication link 22 may be formed between the first communications terminal 102 and the second communications terminal 122 when the transceivers of the first and second communications terminals are aligned. The alignment can be determined using the optical communications beams 20a, 20b to determine when line-of-sight is established between the communications terminals 102, 122. Using the communication link 22, the one or more processors 104 can send communication signals using the optical communications beam 20a to the second communications terminal 122 through free space, and the one or more processors 124 can send communication signals using the optical communications beam 20b to the first communications terminal 102 through free space. The communication link 22 between the first and second communications terminals 102, 122 allows for the bi-directional transmission of data between the two devices. In particular, the communication link 22 in these examples may be free-space optical communications (FSOC) links. In other implementations, one or more of the communication links 22 may be radio-frequency communication links or other type of communication link capable of traveling through free space.

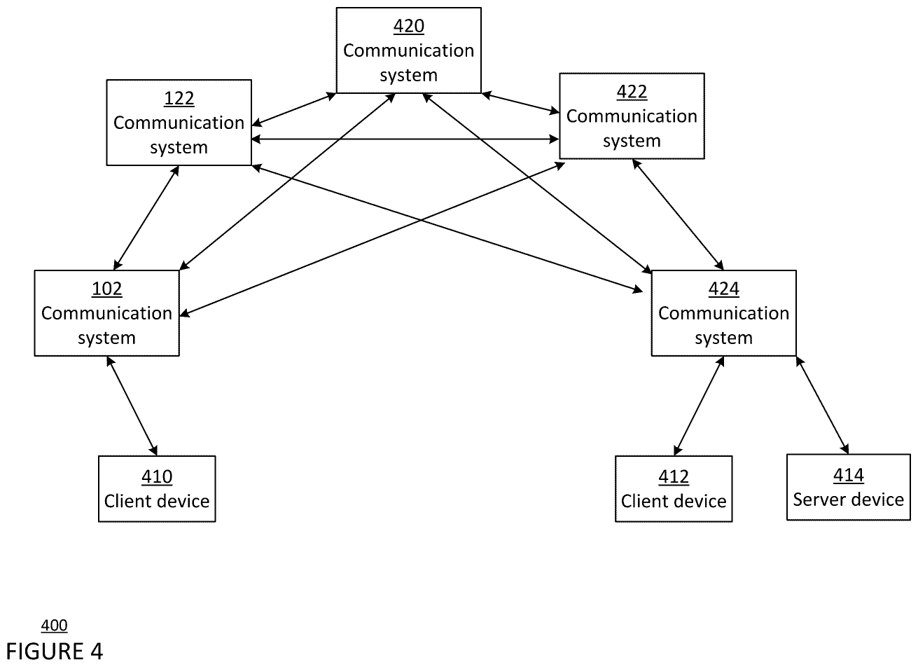

As shown in FIG. 4, a plurality of communications terminals, such as the first communications terminal 102 and the second communications terminal 122, may be configured to form a plurality of communication links (illustrated as arrows) between a plurality of communications terminals, thereby forming a network 400. The network 400 may include client devices 410 and 412, server device 414, and communications terminals 102, 122, 420, 422, and 424. Each of the client devices 410, 412, server device 414, and communications terminals 420, 422, and 424 may include one or more processors, a memory, a transceiver chip, and an OPA architecture (e.g., OPA chip or chips) similar to those described above. Using the transmitter and the receiver, each communications terminal in network 400 may form at least one communication link with another communications terminal, as shown by the arrows. The communication links may be for optical frequencies, radio frequencies, other frequencies, or a combination of different frequency bands. In FIG. 4, the first communications terminal 102 is shown having communication links with client device 410 and communications terminals 122, 420, and 422. The second communications terminal 122 is shown having communication links with communications terminals 102, 420, 422, and 424.

The network 400 as shown in FIG. 4 is illustrative only, and in some implementations the network 400 may include additional or different communications terminals. The network 400 may be a terrestrial network where the plurality of communications terminals is on a plurality of ground communications terminals. In other implementations, the network 400 may include one or more high-altitude platforms (HAPs), which may be balloons, blimps or other dirigibles, airplanes, unmanned aerial vehicles (UAVs), satellites, or any other form of high-altitude platform, or other types of moveable or stationary communications terminals. In some implementations, the network 400 may serve as an access network for client devices such as cellular phones, laptop computers, desktop computers, wearable devices, or tablet computers. The network 400 also may be connected to a larger network, such as the Internet, and may be configured to provide a client device with access to resources stored on or provided through the larger computer network.

### Example Phase Shifter

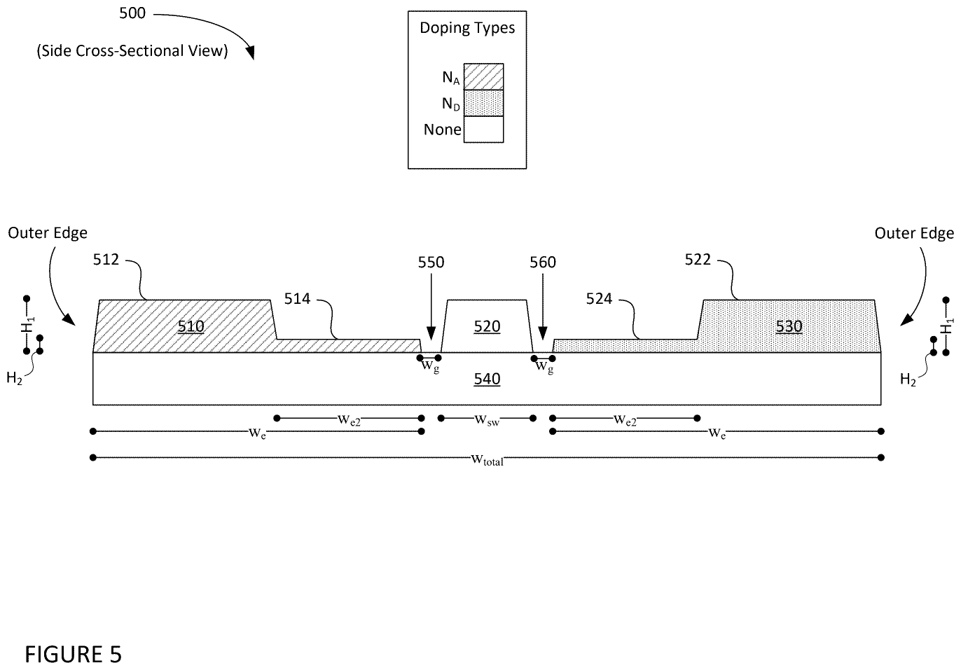

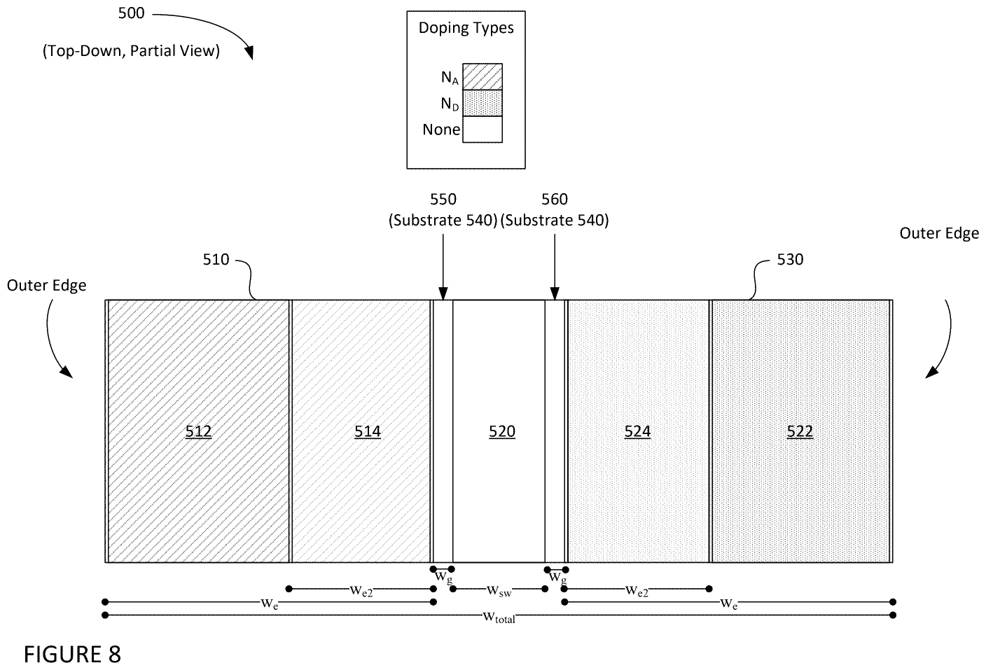

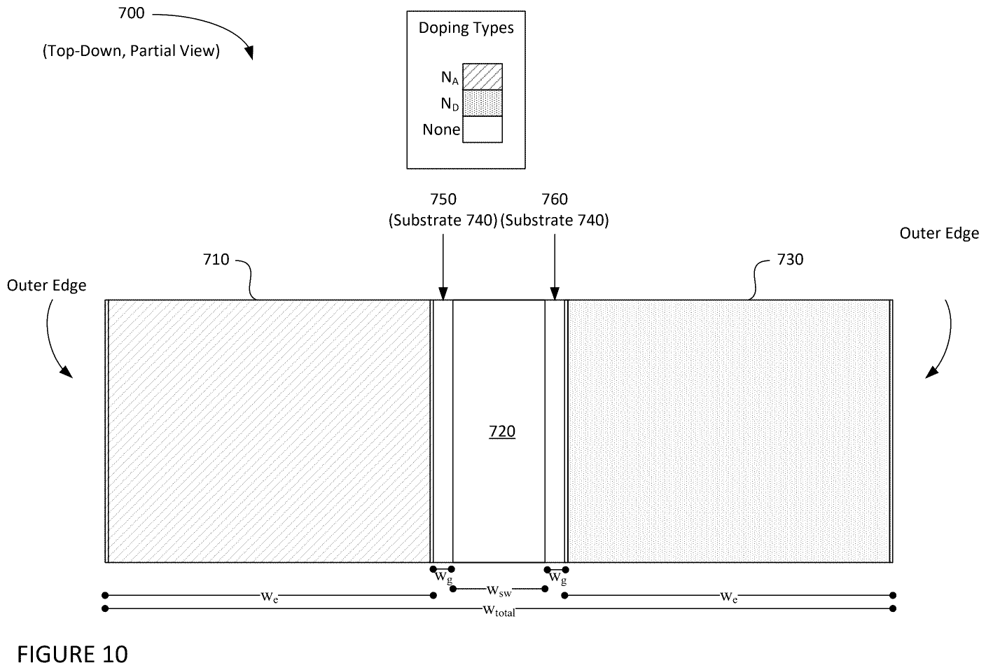

FIGS. 5-8 are example representative views of the architecture of a very small portion of a phase shifter 500, 600, 700 which may correspond to any of the phase shifters 331-335 of the plurality of phase shifters 330. In this regard, FIGS. 5-7 are side, cross-sectional views, and FIGS. 8-10 are partial top-down, perspective views.

Each of the phase shifters 500, 600, 700 may have three primary components, a first electrode 510, 610, 710 a strip waveguide 520, 620, 720 (as opposed to a “rib” waveguide), and a second electrode 530, 630, 730. Each of these is arranged directly on a substrate 540, 640, 740. The substrate may be an insulator such as silicon dioxide material.

Typical rib waveguides may include a base portion and a rib portion arranged on top of the base portion, thus being depicted in cross-section with an upside-down “T-shape”. The base portion may also maintain a connection between the waveguide and the electrodes. In this regard, the strip waveguide 520, 620, 720 has a more rectangular or trapezoid cross-section that does not include the aforementioned base portion or T-shape.

The strip waveguide may be arranged between the first electrode and the second electrode. A first gap 550, 650, 750 may be arranged between the first electrode and the strip waveguide such that there is no physical contact between the first electrode and the strip waveguide. A second gap 560, 660, 760 may be arranged between the second electrode and the strip waveguide such that there is no physical contact between the second electrode and the strip waveguide. These first and second gaps may be considered air or oxide gaps which enable a large field to be applied. In some instances, these gaps may be filled with an insulating material such as silicon dioxide. In other instances, the first electrode, second electrode and waveguide may be lined with other materials with different dielectric and/or breakdown properties.

The first electrode, strip waveguide, and second electrode may each be formed from silicon material such as pure silicon, Si, or silicon based materials such as SiO2 and SiN. To achieve the configurations of FIGS. 5-10, a strip of silicon material arranged on the insulator (e.g., silicon-on-insulator substrate) may be etched. For example, the strip waveguide 520, 620, 720 may be formed from a partially etched strip of silicon material, providing a reduced thickness relative to other portions of the phase shifter. The first and second electrodes may also be formed by partially etching the silicone material.

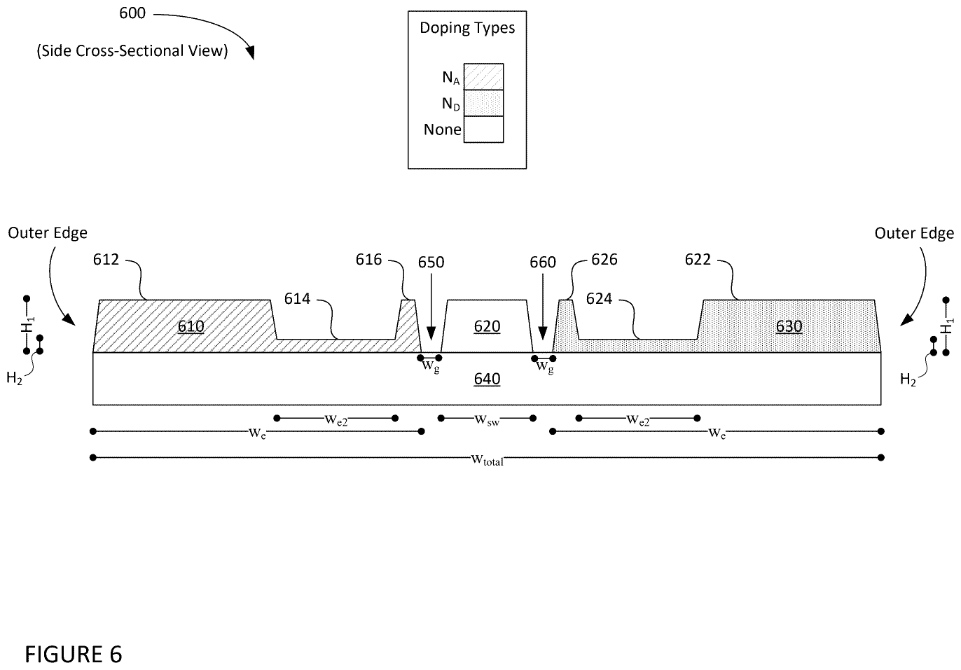

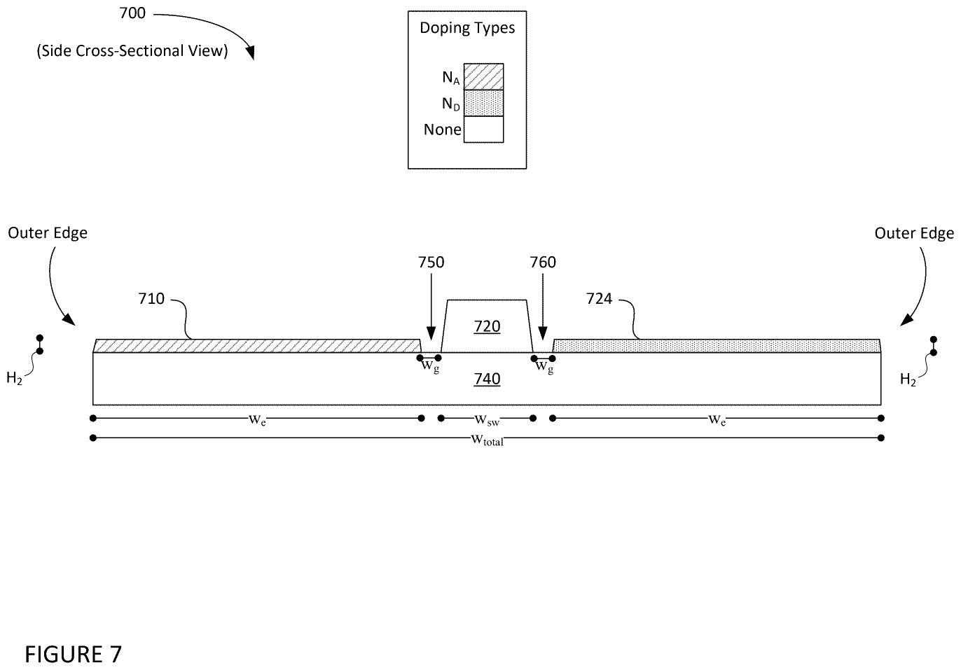

In the examples of phase shifters 500, 600, an outer edge or first portion 512, 522, 612, 622 of each of the first and second electrodes may have very little or no etching (e.g., unetched). Each of the first electrode and second electrode may also include respective second portions 514, 524, 614, 624 which are partially etched or etched to a greater extent than the first portions 512, 522, 612, 622. For the phase shifter 500, as shown in FIG. 5, the partially etched second portions 614, 624 of the first electrode 610 and second electrode 630 may be directly adjacent to the first gap and the second gap, respectively. Alternatively, for the phase shifter 600, as shown in FIG. 6, each of the first and second electrodes may each have a third portion 616, 626 (e.g., a “spike”) with little to no etching arranged directly adjacent to the first gap 650 and the second gap 660, respectively. In this regard, the second portions 614, 624 which are partially etched may be etched to a greater extent than the third portions 616, 626. For the phase shifter 700, as shown in FIG. 7, the first electrode 710 and second electrode 730 may each be partially etched and may also be directly adjacent to the first gap 750 and the second gap 760, respectively. Thus, phase shifter 700 does not include first and second portions with different amounts of etching (e.g., different heights). Rather, first electrode 710 and second electrode 730 may have more consistent etching.

Dopants (holes and electrons) may be implanted within the silicon material in different ways. As a result, the first electrode, strip waveguide and second waveguide may have different doping configurations. For example, first electrode 510, 610, 710 may have p-doping (e.g., hole-doped), the strip waveguide 520, 620, 720 may have no doping, and the second electrode 530, 630, 730 may have n-doping (e.g., electron-doped). Doping level for each electrode may vary. As an example, doping levels may range from ˜10¹⁷ cm⁻³, where cm⁻³ corresponds to a unit of 1/cm³, closer to the strip waveguide 520, 620, 720 to ˜10²⁰ cm⁻³ closer to the outer edges. In the example phase shifters 500, 600, 700, the Nₐ regions or concentration portions correspond to hole-doped or P-type material with greater hole density, and the N_{d} regions or donor concentration portions correspond to electron doped or N-type material with higher electron density.

Turning to the examples, the total width (wₜₒₜₐₗ) of the phase shifter may depend upon the widths of the first and second electrodes, first and second gaps, and the strip waveguide. As an example, the width (w_{sw}) of the strip waveguide 520, 620, 720 may range from 60 nanometers to 2 microns. The width (wₑ) of the first and second electrodes 510, 530, 610, 630, 710, 730 may range from 100 nanometers to 3 microns or more. The widths (wₑ₂) of the second portions 614, 624 may be 1 micron or otherwise may range from 500 nanometers to 1 micron. The width of the first electrode may be approximately the same as the width of the second electrode. The width (w_{g}) of the first and second gaps 550, 560, 650, 660, 750, 760 may range from 100 nanometers to 500 nanometers or more. The width of the first gap 550, 650, 750 may be approximately the same as the width of the second gap 560, 660, 760. The width of the third portions 616, 626 may ideally be as small as possible (e.g., smaller than the strip waveguide), but will be limited by current manufacturing capabilities. In this regard, the width of the third portions may range from 60 nm and 200 nm or more or less.

The height H₁ of the strip waveguide 520, 620, 720 may be approximately 220 nanometers or may otherwise be between 150 and 400 nanometers. The maximum height of the first and second electrodes 510, 530, 610, 630 (e.g., the first portions 512, 522, 612, 622 and third portions 616, 626) may be at least as high as the waveguide up to 400 nanometers. The height H₂ of the second portions 514, 524, 614, 624 may be as low as 50 nanometers but still less than the first portions 512, 522, 612, 622 or third portions 616, 626. Similarly, the first and second electrodes 710, 730 of the phase shifter 700 may also have a height H2 as low as 50 nanometers.

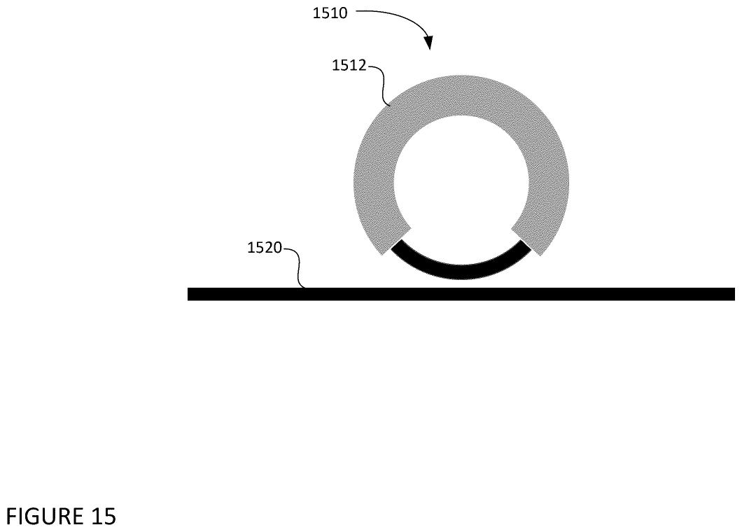

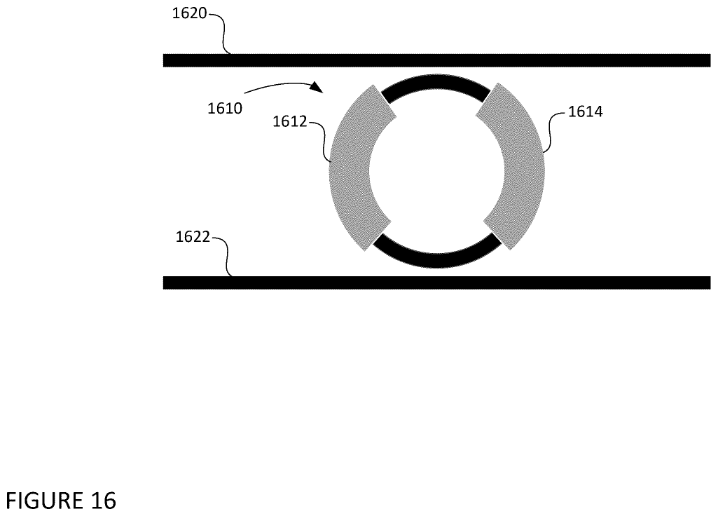

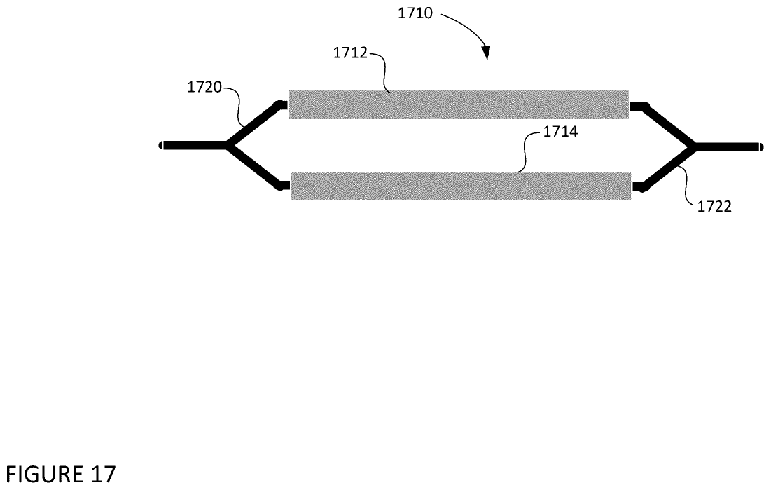

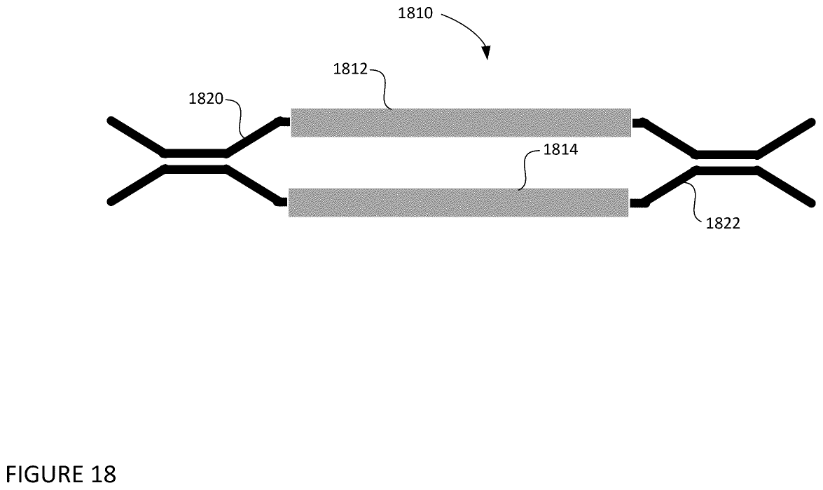

Although not shown, each of the phase shifters 500, 600, 700 may be arranged in various types of configurations such as a ring, stacked loop, coil, etc. In this regard, the outer edge of the first electrode 510, 610 may form an outer edge of a coil shape of the phase shifter 500, 600, 700 and the outer edge of the second electrode 530, 630, 730 may form an inner edge of a coil shape of the phase shifter. The reverse configuration may also be used. Such configurations will depend upon the physical and other features of the devices and systems in which the phase shifters are incorporated. For example, FIG. 15 is an example representation of an all-pass ring modulator 1510 including a phase shifter 1512 depicted with respect to a waveguide 1520. As another example, FIG. 16 is an example representation of an add-drop ring modulator 1610 including two phase shifters 1612, 1614 depicted with respect to a pair of waveguides 1620, 1622. As another example, FIG. 17 is an example representation of a1×1 Mach-Zehnder modulator 1710 including two phase shifters 1712, 1714 depicted with respect to a pair of 1×1 waveguide couplers 1720, 1722. As another example, FIG. 18 is an example representation of a 2×2 Mach-Zehnder modulator 1810 including two phase shifters 1812, 1814 depicted with respect to a pair of 1×2 waveguide couplers 1820, 1822. Each of phase shifters 1512, 1612, 1614, 1712, 1714, 1812, 1814 may be configured the same or similarly as any of phase shifters 500, 600, 700 and/or may be included in an OPA architecture, such as OPA architecture 114 described above.

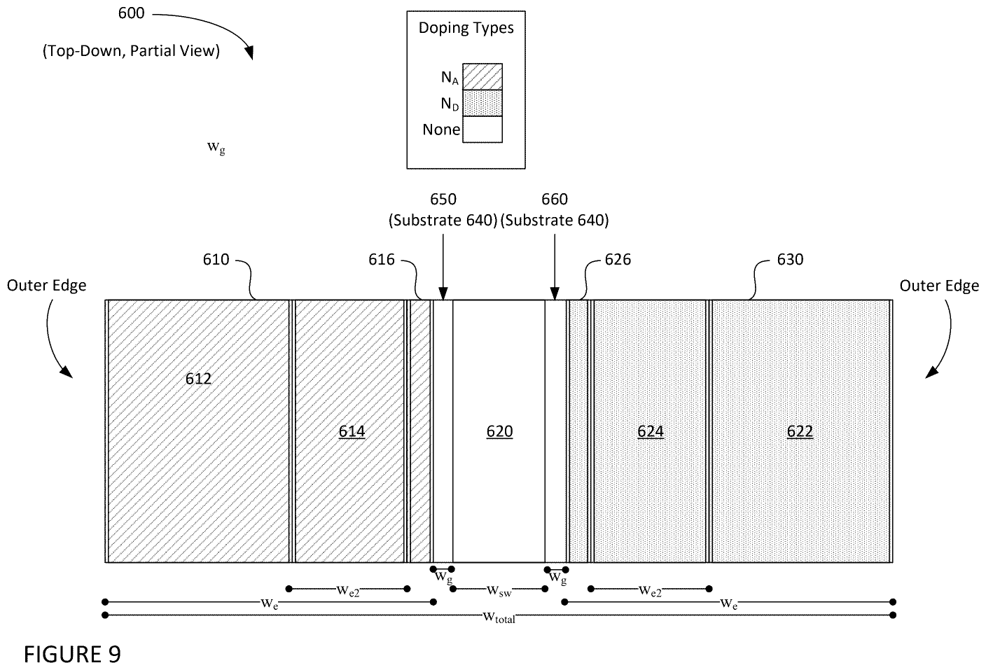

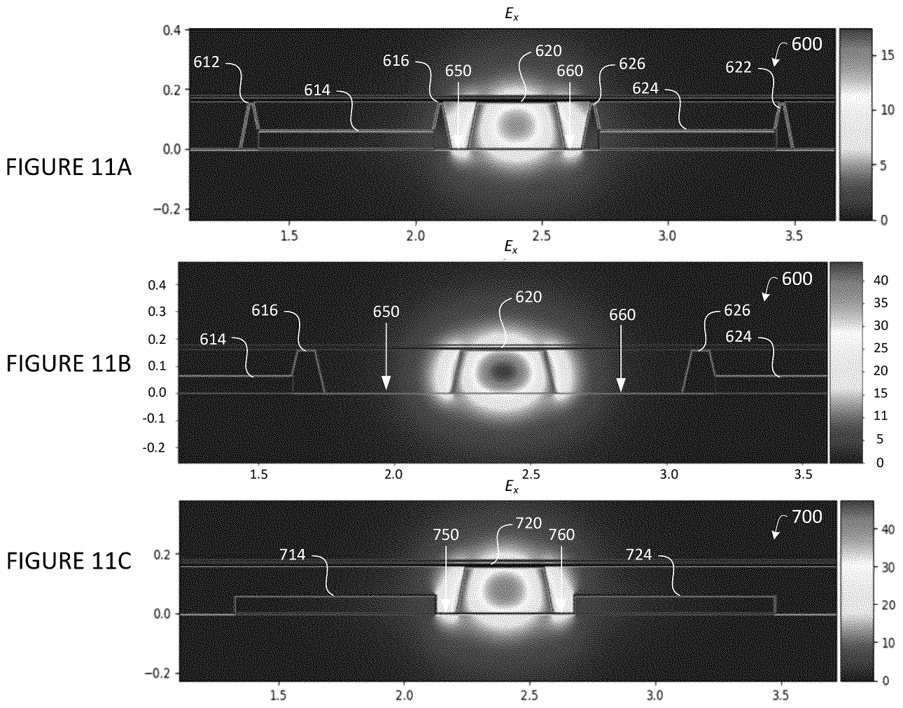

FIGS. 11A-11C represent mode profiles of different phase shifters. In the example of FIG. 11A, the phase shifter may correspond to phase shifter 600, including the third portion 616, 626 of the first and second electrodes 610, 630. Similarly, in the example of FIG. 11B, the phase shifter may correspond to phase shifter 600, including the third portion 616, 626 of the first and second electrodes 610, 630. However, in the example of FIG. 11A, the first and second gaps 650, 660 may be much smaller (here, 100 nanometers) than the first and second gaps 650, 660 of FIG. 9B (here, 500 nanometers). In the example of FIG. 11C, the phase shifter may correspond to phase shifter 700, but with first and second gaps 750, 760 of 100 nanometers.

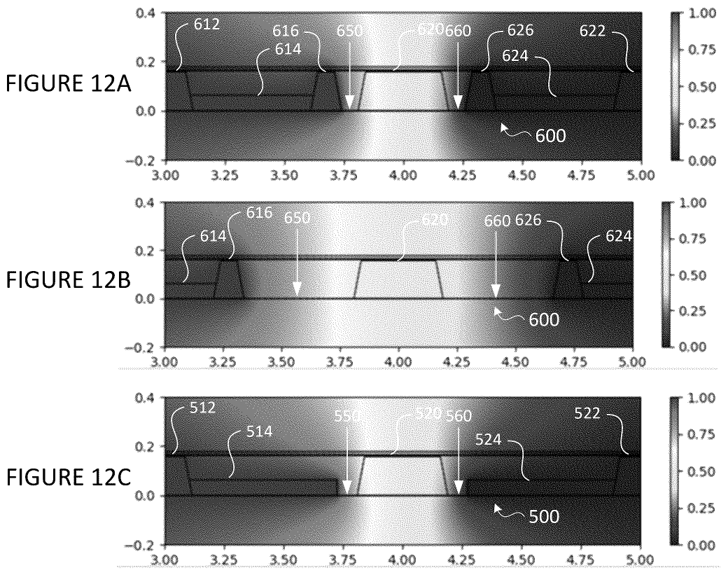

FIGS. 12A-12C represent voltage profiles of different phase shifters. In the example of FIG. 12A, the phase shifter may correspond to phase shifter 600, including the third portion 616, 626 of the first and second electrodes 610, 630. Similarly, in the example of FIG. 12B, the phase shifter may correspond to phase shifter 600, including the third portion 616, 626 of the first and second electrodes 610, 630. However, in the example of FIG. 12A, the first and second gaps 650, 660 may be much smaller (here, 100 nanometers) than the first and second gaps 650, 660 of FIG. 12B (here, 500 nanometers). In the example of FIG. 12C, the phase shifter may correspond to phase shifter 500, but with first and second gaps 550, 560 of 100 nanometers.

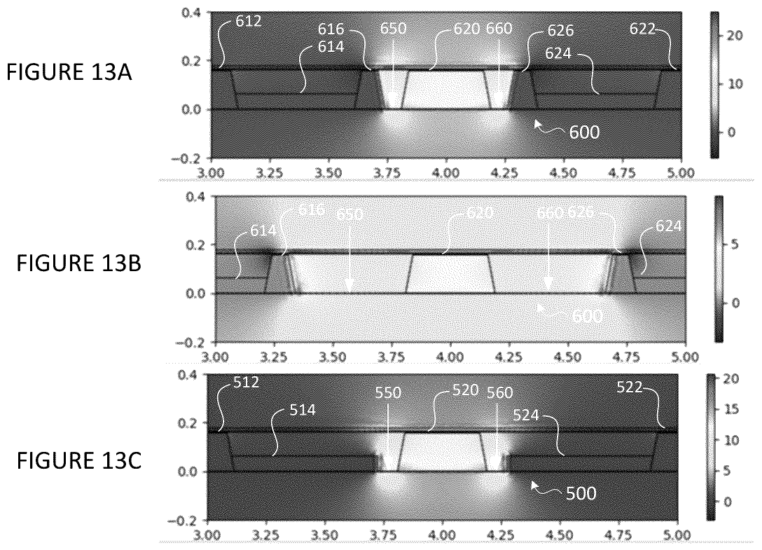

FIGS. 13A-13C represent electric field profiles of different phase shifters. As a reference, the electric field profiles are those defined in the “x-orientation” or “x-axis”. In the example of FIG. 13A, the phase shifter may correspond to phase shifter 600, including the third portion 616, 626 of the first and second electrodes 610, 630. Similarly, in the example of FIG. 13B, the phase shifter may correspond to phase shifter 600, including the third portion 616, 626 of the first and second electrodes 610, 630. However, in the example of FIG. 13A, the first and second gaps 650, 660 may be much smaller (here, 100 nanometers) than the first and second gaps 650, 660 of FIG. 13B (here, 500 nanometers). In the example of FIG. 13C, the phase shifter may correspond to phase shifter 500, but with first and second gaps 550, 560 of 100 nanometers.

As can be seen from the FIGS. 11A-13C, different configurations of the width of the gaps and configurations of the electrodes (e.g., with or without the third portions 616, 626) may have different tradeoffs. For instance, when the gaps are smaller as in FIGS. 11A and 11C, the mode stays strongly confined within the strip waveguide, but the uniformity of the voltage and electric field across the strip waveguide are compromised. In another instance, when each of the first and second electrodes includes a third portion 616, 626 adjacent to the respective first and second gaps as shown in FIGS. 11A, 11B, 12A, and 12B, this increases the voltage and field uniformity relative to the phase shifters 500, 700 (without the third portion) as depicted in FIGS. 11C and 12C, but reduces mode confinement in the guide slightly. The first and second gaps can therefore be increased to increase mode confinement, at the cost of reduced electric field for a fixed voltage.

### Example Methods

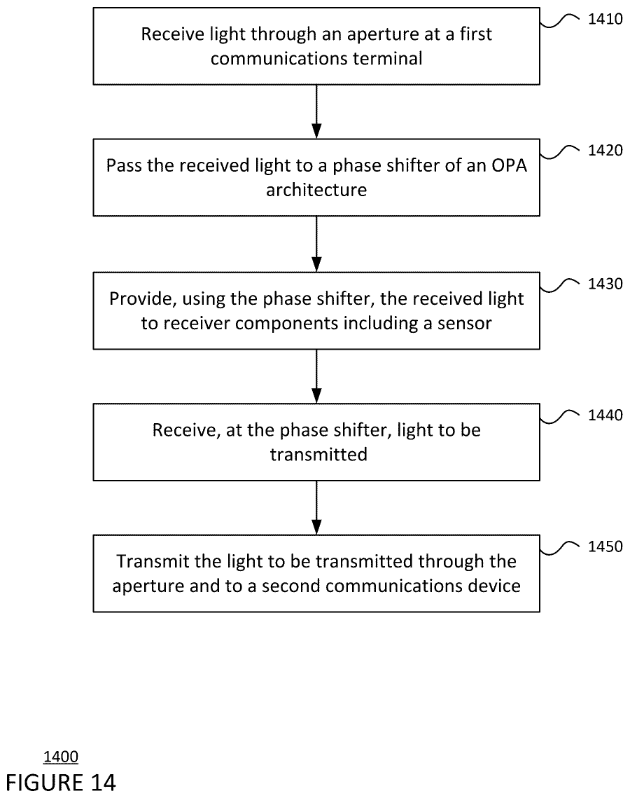

In operation, the one or more processors 104 may perform wavefront sensing and/or correction for optical communication. In FIG. 14, flow diagram 1400 is shown in accordance with some of the aspects described above that may be performed by the one or more processors 104 of the first communication device 102. Additionally, or alternatively, the one or more processors 144 of the second communication device 142 may perform one or more steps of the flow diagram 1400. While FIG. 14 shows blocks in a particular order, the order may be varied and that multiple operations may be performed simultaneously. Also, operations may be added or omitted.

In this example, at block 1410, a first communications terminal receives light through an aperture. For instance, this first communications terminal may be the first communications terminal 102. At block 1420, the received light is passed to a modulator including a phase shifter of an OPA architecture, such as OPA architecture 114. The phase shifter may be configured as described above with regard to phase shifters 500, 600, 700. At block 1430, the phase shifter provides the received light to receiver components including a sensor, such as sensor 118. At block 1440, the phase shifter also receives light to be transmitted. At block 1450, the light to be transmitted is transmitting through the aperture and to a second communications terminal, such as communications terminal 142.

The feature described herein provide for phase shifters which may be used in OPA architectures for optical communications systems. Such phase shifters may provide “ideal” phase modulation utilizing a strip waveguide with an oxide separation to neighboring doped silicon electrodes with partially etched portions. This may greatly reduce currents (and hence charge redistribution) within the waveguide under high electric fields, ensuring that Pockels modulation dominates over free carrier modulation. In addition, this may allow for an approximately 100 times greater electric field—and hence optical phase shift—to be applied across the waveguide, since the breakdown field of silicon dioxide is ˜10⁷ V/cm, whereas reverse-biased silicon's is up to ˜10⁵ V/cm.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A phase shifter consisting of a silicon material, the phase shifter having:
a first electrode;
a strip waveguide; and
a second electrode, wherein the strip waveguide is arranged between the first electrode and the second electrode such that there is a first gap between the first electrode and the strip waveguide such that there is no physical contact between the first electrode and the strip waveguide and there is a second gap between the second electrode and the strip waveguide such that there is no physical contact between the second electrode and the strip waveguide, wherein the first electrode is hole-doped, the strip waveguide has no doping, and the second electrode is electron-doped.

2. The phase shifter of claim 1, wherein the silicon material is one of Si, SiO₂, or SiN.

3. The phase shifter of claim 1, wherein the first electrode includes a first portion having a first height and a second portion having a second height, wherein the first height is greater than the second height.

4. The phase shifter of claim 3, wherein the second portion is directly adjacent to the first gap.

5. The phase shifter of claim 3, wherein the first portion is an unetched portion, the second portion is a partially etched portion, and the first gap is fully etched.

6. The phase shifter of claim 3, wherein the second portion is adjacent to a third portion of the first electrode, and a height of the third portion is greater than a height of the second portion.

7. The phase shifter of claim 6, wherein the third portion is directly adjacent to the first gap.

8. The phase shifter of claim 6, wherein the first portion is an unetched portion, the second portion is a partially etched portion, the third portion is an unetched portion, and the first gap is fully etched.

9. The phase shifter of claim 3, wherein the first portion is arranged at an outer edge of the phase shifter.

10. The phase shifter of claim 1, further comprising a substrate wherein the first electrode, second electrode, and strip waveguide are arranged directly on the substrate.

11. A system comprising:
a first communications terminal comprising:
an optical phased array (OPA) architecture including a plurality of phase shifters configured to receive an optical communications beam from a second communications terminal, wherein the plurality of phase shifters includes a first phase shifter consisting of silicon material, the first phase shifter having:
a first electrode;
a strip waveguide; and
a second electrode, wherein the strip waveguide is arranged between the first electrode and the second electrode such that there is a first gap between the first electrode and the strip waveguide such that there is no physical contact between the first electrode and the strip waveguide and there is a second gap between the second electrode and the strip waveguide such that there is no physical contact between the second electrode and the strip waveguide, wherein the first electrode is hole-doped, the strip waveguide has no doping, and the second electrode is electron-doped.

12. The system of claim 11, wherein the first electrode includes a first portion having a first height and a second portion having a second height, wherein the second height is greater than the first height.

13. The system of claim 12, wherein the second portion is directly adjacent to the first gap.

14. The system of claim 12, wherein the first portion is an unetched portion, the second portion is a partially etched portion, and the first gap is fully etched.

15. The system of claim 12, wherein the second portion is adjacent to a third portion of the first electrode, and the second height of the second portion is greater than a height of the third portion.

16. The system of claim 15, wherein the first portion is an unetched portion, the second portion is a partially etched portion, the third portion is an unetched portion, and the first gap is fully etched.

17. The system of claim 12, wherein the first portion is arranged at an outer edge of the first phase shifter.

18. The system of claim 11, further comprising a substrate wherein the first electrode, second electrode, and strip waveguide are arranged directly on the substrate.

19. The system of claim 11, further comprising the second communications terminal, the second communications terminal having a second OPA architecture including a plurality of phase shifters configured to receive an optical communications beam from the first communications terminal, wherein the plurality of phase shifters includes a second phase shifter having a same configuration as the first phase shifter.

20. A method comprising:
receiving, at a first communications terminal, light through an aperture;
passing the received light to a phase shifter of an OPA architecture, the phase shifter consisting of silicon material, the phase shifter having:
a first electrode;
a strip waveguide; and
a second electrode, wherein the strip waveguide is arranged between the first electrode and the second electrode such that there is a first gap between the first electrode and the strip waveguide such that there is no physical contact between the first electrode and the strip waveguide and there is a second gap between the second electrode and the strip waveguide such that there is no physical contact between the second electrode and the strip waveguide, wherein the first electrode is hole-doped, the strip waveguide has no doping, and the second electrode is electron-doped;
providing, using the phase shifter, the received light to receiver components including a sensor;
receiving, using the phase shifter, light to be transmitted; and
transmitting the light to be transmitted through the aperture and to a second communications terminal.
